(19) United States
(12) Patent Application Publication
(10) Pub. No.: US 2014/0271424 A1
(43) Pub. Date: Sep. 18, 2014

(54) APPARATUS AND METHOD FOR AFTER-TREATMENT OF EXHAUST EMISSION FROM DIESEL ENGINE

(71) Applicants: Guangdi HU, (US); Shaojun SUN, Weifang, Shandong (CN); Weichai Power Co., Ltd., Weifang, Shandong (CN)

(72) Inventors: Guangdi Hu, Weifang (CN); Shaojun Sun, Weifang (CN)

(73) Assignee: WEICHAI POWER CO., LTD., Weifang, Shandong (CN)

(21) Appl. No.: 14/350,557

(22) PCT Filed: Oct. 9, 2011
(86) PCT No.: PCT/CN2011/080562

§ 371 Date: Apr. 8, 2014

(51) Int. Cl. B01D 53/94

(52) U.S. Cl. CPC B01D 53/9431
USPC 423/212; 422/108

(57) ABSTRACT

An apparatus (100) used in a selective catalytic reduction system of a diesel engine is disclosed, wherein the SCR system comprises a catalyst to use ammonia to convert nitrogen oxides discharged from the diesel engine, the apparatus (100) comprising: an acquiring module (102) coupled to the catalyst and configured to acquire a measurement value of at least one operation condition of the catalyst; and a determining module (104) coupled to the acquiring module and configured to determine ammonia storage capacity of the catalyst based on the acquired measurement value so as to determine ammonia surface coverage of the catalyst. A corresponding method and a computer program product thereof are further disclosed. According to the apparatus (100) and method, the ammonia surface coverage and ammonia storage capacity of the catalyst may be estimated more accurately.

### FIELD OF THE INVENTION

The embodiments of the invention relate generally to a diesel engine, and more particularly, relates to an apparatus and method for after-treatment of exhaust gas emission of a diesel engine.

### BACKGROUND OF THE INVENTION

In the current field of diesel engines, selective catalytic reduction (SCR) is an important after-treatment system for processing exhaust gas emitted by an engine. An SCR after-treatment system generally includes: urea aqueous solution tank, transport means, metering means, ejection means, catalyst, temperature and exhaust gas sensors, etc. The basic working principle of the SCR after-treatment system is that the exhaust gas, after being discharged from an engine turbo, enters into an exhaust gas mixing tube; a urea metering ejection means is installed on the exhaust gas mixing tube; with injection of a urea aqueous solution, urea hydrolysis and pyrolysis reaction occurs at a high temperature, thereby producing ammonia (NH3). Catalyst, using urea as a reducing agent, converts the nitrogen oxide (NOx) in the exhaust gas into nitrogen (N2) and water.

In the SCR after-treatment system, the control of urea ejection amount is critical. Excessive urea ejection will lead to leakage of ammonia, while too little urea ejection will result in lower conversion efficiency of nitrogen oxide NOx. To design a urea ejection control strategy for the SCR after-treatment system, it is needed to determine the state information of an SCR after-treatment catalytic system. In the prior art, temperature, air flow, NOx concentration and ammonia concentration may be measured in real-time using sensors. However, it is currently in practice unable to perform a direct and accurate measurement of ammonia surface coverage of catalyst carrier.

It would be appreciated that the ammonia surface coverage of catalyst carrier would directly affect the concentrations of the nitrogen oxide NOx and ammonia in the exhaust gas, while the concentrations of the nitrogen oxide NOx and ammonia in the exhaust gas are two most important states in designing an SCR after-treatment urea injection amount controller. The design of an SCR after-treatment urea injection amount controller may achieve the objective of minimizing the concentration of nitrogen oxide NOx in the exhaust gas and the ammonia leakage through controlling the ammonia surface coverage of catalyst carrier.

As the ammonia surface coverage of catalyst carrier can not use conventional sensors, it is compulsory to design special means to determine or estimate it. Such means is often referred to as an observer in the art. Existing state observers for the ammonia surface coverage of catalytic carrier mainly include a linear observer and a Kalman filtering-based observer.

On the other hand, ammonia storage capacity of the catalyst is also a factor that should be considered by the controller for the SCR after-treatment urea ejection amount. At present, in a control-oriented SCR after-treatment system, the ammonia storage capacity is often assumed to be constant. However, studies show that the ammonia storage capacity of the SCR after-treatment catalyst decreases with aging of the SCR after-treatment catalyst. It is generally believed that, when time and temperature vary, the ammonia storage capacity of the SCR after-treatment catalyst has a high uncertainty. For this reason, the ammonia surface coverage of the SCR after-treatment catalyst carrier is selected as a control variable to design a robust controller for urea ejection amount.

According to the definition of the ammonia surface coverage of the SCR after-treatment catalyst carrier, there is an inverse proportional relationship between ammonia storage capacity and the ammonia surface coverage. Therefore, if the ammonia surface coverage is chosen as a control variable, the ammonia storage capacity has to be determined. Moreover, the current emission regulations require an On-Board Diagnostics (OBD) system to monitor the health condition of the SCR after-treatment system. Ammonia storage capacity is an important factor that directly reflects SCR aging. Estimation of the ammonia storage capacity of the SCR after-treatment catalyst is essential for the OBD to determine the SCR health condition. Existing ammonia storage capacity state observers include Kalman filtering-based observer.

The existing Kalman filtering-based state observers for ammonia surface coverage and ammonia storage capacity are designed on the assumption of SCR catalyst aging-induced slow time-varying ammonia storage capacity kinetics or temperature-related rapid time-varying ammonia storage capacity kinetics. The disadvantage of this design lies in that: the kinetic mechanism for the ammonia storage capacity remains uncertain, while the actual ammonia storage capacity kinetics may be much more complex.

Thus, in the prior art, there is a need for a more effective solution to adaptively determine the ammonia surface coverage and the ammonia storage capacity of the SCR after-treatment carrier.

### SUMMARY OF THE INVENTION

To overcome the above-mentioned drawbacks in the prior art, embodiments of the invention provide an apparatus and method for adaptively determining ammonia surface coverage and ammonia storage capacity of the catalyst in an SCR after-treatment system.

In a first aspect of the present invention, there is provided an apparatus used in a selective catalytic reduction (SCR) system of a diesel engine, the SCR system comprising a catalyst to use ammonia to convert nitrogen oxides discharged from the diesel engine. The apparatus comprises: an acquiring module coupled to the catalyst and configured to acquire a measurement value of at least one operation condition of the catalyst; and a determining module coupled to the acquiring module and configured to determine ammonia storage capacity of the catalyst based on the acquired measurement value so as to determine ammonia surface coverage of the catalyst.

According to some embodiments of the present invention, the determining module comprises: a joint determining module configured to determine the ammonia surface coverage of the catalyst based on the acquired measurement value along with the ammonia storage capacity of the catalyst. Alternatively, the joint determining module comprises: a model-based determining module configured to determine the ammonia storage capacity of the catalyst and the ammonia surface coverage of the catalyst with the measurement value as an independent variable by using a reaction model that characterizes chemical reaction properties of the catalyst.

According to some embodiments of the present invention, the model-based determining module further comprises: a calculating module configured to calculate an observation value of at least one operation condition based on the acquired measurement value; and a first determining module configured to determine the ammonia storage capacity of the catalyst and the ammonia surface coverage of the catalyst using the measurement value and the observation value based on the reaction model.

According to some embodiments of the present invention, the acquiring module comprises at least one of: a first concentration acquiring module configured to acquire concentration of nitrogen oxides in the catalyst; a second concentration acquiring module configured to acquire ammonia concentration in the catalyst; and a temperature acquiring module configured to acquire temperature in the catalyst.

In a second aspect of the present invention, there is provided a method used in a selective catalytic reduction (SCR) system of a diesel engine, the SCR system comprising a catalyst to use ammonia to convert nitrogen oxides discharged from the diesel engine. This method comprises: acquiring a measurement value of at least one operation condition of the catalyst; and determining ammonia storage capacity of the catalyst based on the acquired measurement value so as to determine ammonia surface coverage of the catalyst.

According to some embodiments of the present invention, the determining ammonia storage capacity of the catalyst based on the acquired measurement value so as to determine ammonia surface coverage of the catalyst comprises: determining the ammonia surface coverage of the catalyst based on the acquired measurement value along with the ammonia storage capacity of the catalyst. Optionally, the determining the ammonia surface coverage of the catalyst based on the acquired measurement value along with the ammonia storage capacity of the catalyst comprises: determining the ammonia storage capacity of the catalyst and the ammonia surface coverage of the catalyst with the measurement value as an independent variable by using a reaction model that characterizes chemical reaction properties of the catalyst.

According to some embodiments of the present invention, the determining the ammonia storage capacity of the catalyst and the ammonia surface coverage of the catalyst with the measurement value as an independent variable by using a reaction model that characterizes chemical reaction properties of the catalyst comprises: calculating an observation value of at least one operation condition based on the acquired measurement value; and determining the ammonia storage capacity of the catalyst so as to determine the ammonia surface coverage of the catalyst using the reaction model based on the measurement value and the observation value.

According to some embodiments of the present invention, the acquiring a measurement value of at least one operation condition of the catalyst comprises acquiring at least one of: concentration of nitrogen oxides in the catalyst, ammonia concentration in the catalyst; and temperature in the catalyst.

In a third aspect of the present invention, there is provided a computer program product having a computer instruction program included in a computer readable storage medium, wherein when the program is executed by a device, the device is caused to perform corresponding actions, the program comprising: a first instruction configured to acquire a measurement value of at least one operation condition of the catalyst; and a second instruction configured to determine ammonia storage capacity of the catalyst based on the acquired measurement value so as to determine ammonia surface coverage of the catalyst.

Those skilled in the art would appreciate through the following description that, by using the embodiments of the present invention, when determining or estimating the ammonia surface coverage of a catalyst based on the measured operation condition of the catalyst, it would be unnecessary to always suppose the ammonia storage capacity of the catalyst to be a constant or determine it based on a specific kinetics property, like in the prior art. In contrast, embodiments of the present invention make no suppositions regarding the kinetics properties of the ammonia storage capacity, which can be a constant or a variable. In particular, the ammonia storage capacity and the ammonia surface coverage of the catalyst can be determined simultaneously based on a chemical reaction model of the catalyst.

The ammonia storage capacity and the ammonia surface coverage determined in this way can reflect the physical characteristics of the SCR catalyst more realistic and accurately. Further, the solution proposed in the present invention is easy to implement and operate in practice.

### BRIEF DESCRIPTION OF THE DRAWINGS

Through reading the following detailed description with reference to the accompanying drawings, the above and other objectives, features and advantages of the embodiments of the present invention will become more comprehensible. In the drawings, a plurality of embodiments of the present invention will be illustrated in an exemplary and non-limiting manner, wherein:

FIG. 1 shows a block diagram of an apparatus 100 used in an SCR system according to an exemplary embodiment of the present invention;

FIG. 2 shows a block diagram of an apparatus 200 used in an SCR system according to an exemplary embodiment of the present invention;

FIG. 3 shows a block diagram of a joint determining module according to an exemplary embodiment of the present invention;

FIG. 4 shows a flowchart of a method 400 used in a SCR system according to an exemplary embodiment of the present invention.

In the drawings, same or corresponding reference signs indicate the same or corresponding parts.

### DETAILED DESCRIPTION OF THE EMBODIMENTS

Hereinafter, the principle and spirit of the present invention will be described with reference to various exemplary embodiments. It should be understood that provision of these embodiments is only to enable those skilled in the art to better understand and further implement the present invention, not intended for limiting the scope of the present invention in any manner.

Additionally, the term “parameter” used herein indicates any value of physical quantity that can indicate the (target or actual) physical state or operation condition of the diesel engine. Moreover, in the context of this specification, a “parameter” may be used interchangeably with the physical quantity represented thereby. For example, “a parameter indicating concentration” has an equivalent meaning herein with “concentration.” Besides, the term “acquire” as used herein includes various of currently existing or future developed means, for example, measure, read, estimate, predict, and the like.

Hereinafter, the principle and spirit of the present invention will be described in detail with reference to several representative embodiments of the present invention. First, refer to FIG. 1, which shows a schematic diagram of an apparatus 100 used in a selective reduction reaction (SCR) system.

As indicated above, the SCR system comprises a catalyst. The catalyst, usually using urea as a reducing agent, converts the nitrogen oxides (NOx) in the exhaust gas into nitrogen (N₂) and water. As shown in FIG. 1, the apparatus 100 comprises an acquiring module 102 that may be coupled to the catalyst in the SCR system and configured to acquire a measurement value of at least one operation condition of the catalyst.

Besides, the apparatus 100 further comprises a determining module 104 that is coupled to the acquiring module 102 and configured to determine ammonia storage capacity of the catalyst based on the acquired measurement value so as to determine ammonia surface coverage of the catalyst. The specific operations and features of the acquiring module 102 and the determining module 104 will be detailed infra.

Now, refer to FIG. 2, which shows a schematic diagram of an apparatus 200 used in a selective reduction reaction (SCR) system. The apparatus 200 is a specific and detailed implementation of the above depicted apparatus 100. The apparatus 200 comprises an acquiring module 202 and a determining module 204 coupled to the acquiring module 202. Hereinafter, the features of the apparatus 200 will be depicted in detail with reference to specific examples.

In some embodiments of the present invention, ammonia storage capacity and ammonia surface coverage of the catalyst may be determined based on at least one of the following operation condition measurement values: concentration of nitrogen oxides in the catalyst, ammonia concentration in the catalyst; and temperature in the catalyst. Correspondingly, in these embodiments, the acquiring module 202 may comprise at least one of the following: a first concentration acquiring module 2022 configured to acquire a concentration of nitrogen oxides in the catalyst; a second concentration acquiring module 2024 configured to acquire ammonia concentration in the catalyst; and a temperature acquiring module 2026 configured to acquire temperature in the catalyst.

As an example, a first concentration acquiring module 2022 and a second concentration acquiring module 2024 may be configured to acquire the measurement value of the concentration of the nitrogen oxides and the measurement value of the ammonia concentration using appropriate sensors, respectively. Likewise, the temperature acquiring module 2026, for example, may be configured to acquire a measurement value of temperature of the catalyst using an appropriate temperature sensor. Particularly, according to some embodiments, an upstream temperature sensor and a downstream temperature sensor may be disposed at an inlet end and an outlet end of the catalyst, respectively. At this point, the temperature acquiring module 2026 in the acquiring module 202 of the device 200 may estimate the temperature of the catalyst based on the measurement values of the upstream temperature sensor and the downstream temperature sensor. For example, the temperature of the catalyst may be calculated to be an arithmetic average value or a weighted average value of the upstream temperature and the downstream temperature.

Note that what are depicted above are only several feasible examples, and any other currently known or future developed appropriate technical means may be used to acquire the operation condition measurement value of the catalyst. The scope of the present invention is not limited thereto.

In one alternative embodiment of the present invention, the ammonia storage capability and ammonia surface coverage of the catalyst may be determined simultaneously in a combined manner. In other words, when determining the ammonia surface coverage of the catalyst, the ammonia storage capability is not necessarily a constant, but optionally a dependent variable determined along with the ammonia surface coverage. Correspondingly, in such an embodiment, the determining module 204 of the apparatus 200 may comprise a joint determining module 2042 that is configured to determine the ammonia surface coverage of the catalyst based on the acquired measurement value along with the ammonia storage capability of the catalyst.

The joint determining module 2042 may simultaneously determine the ammonia storage capacity and the ammonia surface coverage of the catalyst through any appropriate manner. For example, in some embodiments of the present invention, the joint determining module may comprise a model-based determining module (not shown) configured to determine the ammonia storage capacity and the ammonia surface coverage of the catalyst with the measurement value as an independent variable by using a model characterizing a chemical reaction feature of the catalyst.

In such an embodiment, a reaction model characterizing chemical reaction properties of the SCR catalyst may be built through any currently known or future developed appropriate means. Based on the reaction model, the determining module 204 uses the catalyst operation condition measurement value as acquired by the acquiring module 202 as an independent variable so as to simultaneously determine or estimate the ammonia storage capacity and the ammonia surface coverage of the catalyst. In other words, the ammonia storage capacity and the ammonia surface coverage of the catalyst act as dependent variables in the reaction model. Hereinafter, a specific example of the reaction model will be depicted, wherein the independent variables of the reaction model comprise concentration of nitrogen oxides in the catalyst, ammonia concentration in the catalyst; and temperature in the catalyst.

In this embodiment, as depicted above, the temperature acquiring module 2026, for example, may acquire the measurement value of the catalyst temperature in the following manner:

$$T = \frac{{T}_{Us} + {T}_{Ds}}{2} \qquad ( 1 )$$

wherein T_{Us} and T_{Ds} denote the upstream temperature and downstream temperature of the catalyst, respectively.

The ammonia storage capacity of the catalyst is represented by Ω, and the ammonia surface coverage of the catalyst is represented by Θ_{NH}_{₃}. The model characterizing the chemical reaction properties in the catalyst, i.e., reaction model, may be built in the following manner:

\dot{Θ}_{NH}_{₃}=c_{NH}_{₃}a₃(T)(1−Θ_{NH}_{₃})−[a₄(T)+a₅(T)c_{NO}_{ₓ}+a₆(T)]ΘΘ_{NH}_{₃} (2)

ċ_{NO}_{ₓ}=a₁n_{NO}_{ₓ}_{,in}*−c_{NO}_{ₓ}(a₀a₁m_{EG}*T+a₅(T)ΩΘ_{NH}_{₃}) (3)

ċ_{NH}_{₃}=a₁n_{NH}_{₃}_{,in}*−c_{NH}_{₃}[a₀a₁m_{EG}T+a₃(T)Ω(1−Θ_{NH}_{₃})]+a₄(T)ΩΘ_{NH}_{₃} (4)

In equations (3)-(4), the temperature T, nitrogen oxides concentration measurement value c_{NOx}, and the nitrogen concentration measurement value c_{NH3} are independent variables. The other constants are defined as follows:

$${a}_{0} = \frac{{R}_{S , EG}}{{P}_{amb}} ;$$

R_{S, EG}: engine exhaust gas constant (J/kgK);
P_{amb}: ambient pressure (pa);

$${a}_{1} = \frac{{n}_{Cell}}{ɛ {V}_{C}} ;$$

n_{Cell}: number of catalyst infinitesimal cell;
V_{C}: catalyst volume (m³);
ε: void ratio;

$${a}_{3} ( T ) = {S}_{C} {α}_{Prob} \sqrt{\frac{R T}{2 π {Mr}_{{NH}_{3}}} ;}$$

C_{S}: ammonia absorption capacity, concentration of catalyst surface active atom (mol/m3);
S_{C}: area of surface active atoms (m²/mol);
α_{Prob}: adhesion probability;
R: gas constant (J/molK);
Mr_{NH}_{₃}: molecular weight of NH₃
m*_{EG}: flow rate of exhaust gas mass (kg/s);

$${a}_{4} ( T ) = {k}_{Des} {e}^{( \frac{- {E}_{a , Des}}{RT} )} ;$$

k_{Des}: desorption reaction rate of NH3 (mol/m³ s);
E_{aDes}: desorption frequency factor of NH₃;

$${a}_{5} ( T ) = {RTk}_{SCR} {e}^{( \frac{- {E}_{a , SCR}}{RT} )} ;$$

k_{SCR}: frequency factor of SCR chemical reaction (m²/Nₛ);
E_{aSCR}: activation energy of SCR chemical reaction (J/mol);

$${a}_{6} ( T ) = {k}_{Ox} {e}^{( \frac{- {E}_{a , Ox}}{RT} )}$$

k_{OX}: frequency factor of NH3 oxidization reaction (m²/Nₛ);
E_{aOX}: activation energy of NH3 oxidization reaction (J/mol);
n_{NO}_{ₓ}_{,in}*: nitrogen oxides concentration in the original emission of the diesel engine;
n_{NH}_{₃}_{,in}*: ammonia concentration ejected from the urea pump.

Note that it is only an example of the chemical reaction model characterizing the catalyst that is built in equations (2)-(4), which is not intended to limit the scope of the present invention. The chemical reaction model of the SCR catalyst may be built in any appropriate manner with the operation condition measurement value of the SCR catalyst as an independent variable, and the ammonia storage capacity and ammonia surface coverage of the catalyst as dependent variables.

Based on the reaction model of the SCR catalyst as built (for example, the exemplary reaction model as depicted above), the model-based determining module may determine the ammonia storage capacity and the ammonia surface coverage of the catalyst by solving the equation set representing the model. For example, the exemplary catalyst reaction model as built above through equations (2)-(4) may be still considered as an example. Based on equations (2)-(4), the following vector equation may be derived:

\dot{x}=Ax+φ(x,u)+Ωƒ(x) (5)

wherein u=n_{NH}_{₃}_{,in}* acts as the control quantity, and wherein:

$$x = \{ \begin{matrix}{Θ}_{{NH}_{3}} \\ {c}_{{NO}_{x}} \\ {c}_{{NH}_{3}}\end{matrix} \}$$

$$A = [ \begin{matrix}- ( {a}_{4} ( T ) + {a}_{1} & 0 & 0 \\ 0 & - {a}_{0} {a}_{1} {m}_{EG}^{*} T & 0 \\ 0 & 0 & - {a}_{0} {a}_{1} {m}_{EG}^{*} T\end{matrix} ]$$

$$φ ( x , u ) = \{ \begin{matrix}{c}_{{NH}_{3}} {a}_{3} ( T ) ( 1 - {Θ}_{{NH}_{3}} ) - {a}_{5} ( T ) {Θ}_{{NH}_{3}} {c}_{{NO}_{x}} \\ {a}_{1} {n}_{{NO}_{x} , in}^{*} \\ {a}_{1} u\end{matrix} \}$$

$$f ( x ) = \{ \begin{matrix}0 \\ - {a}_{5} ( T ) {Θ}_{{NH}_{3}} {c}_{{NO}_{x}} \\ {c}_{4} ( T ) {Θ}_{{NH}_{3}} - {a}_{3} ( T ) {c}_{{NH}_{3}} ( 1 - {Θ}_{{NH}_{3}} )\end{matrix} \}$$

Here, in order to more accurately determine the ammonia storage capability and the ammonia surface coverage of the catalyst simultaneously, according to some embodiments of the present invention, the measurement value of the catalyst operation condition as acquired by the acquiring module 202 may be further processed. For example, the model-based determining module in the joint determining module 2042 may comprise: a calculating module configured to measure an observation value of a corresponding operation condition based on the acquired measurement value; and a first determining module (not shown) configured to determine ammonia storage capacity of the catalyst and ammonia surface coverage of the catalyst using the measurement value and the observation value of the operation condition based on the reaction model.

Specifically, as an example, the model-based determining module may be operated to enable the nonlinear functions φ(x,u) and ƒ(X) to satisfy Lipchitz condition, then

∥φ(x,u)−φ(\hat{x},u)∥≦α₁∥x−\hat{x}∥

∥ƒ(x)−ƒ(\hat{x})∥≦α₂∥x−\hat{x}∥

wherein α₁ and α₂ are constants. Meanwhile, the following Lyapunov function is considered:

$$V = \frac{1}{3} {e}^{T} e + \frac{1}{2} ρ {\tilde{Ω}}^{2}$$

wherein e=x−\hat{x} and \tilde{Ω}=Ω−\hat{Ω}, \hat{x} denotes the state observation value of X, \hat{Ω} denotes the estimation value of Ω, and ρ>0 denotes a weight factor constant.

Therefore, the model-based determining module may determine the observation values of respective operation condition measurement values in the following manner and correspondingly determine the ammonia storage capacity and the ammonia surface coverage of the catalyst, such that:

$$\begin{matrix} {{T}^{\dot{\hat{}}}}_{Ds} = {a}_{7} {m}_{EG}^{*} ( {T}_{Us} - {\hat{T}}_{Ds} ) - {a}_{9} ( {\hat{T}}_{DS}^{4} - {T}_{amb}^{4} ) + {L}_{1} ( {T}_{Us} - {\hat{T}}_{Us} ) & ( 6 ) \\ \hat{T} = \frac{{T}_{Us} + {T}_{Ds}}{2} & ( 7 ) \\ {{Θ}^{\dot{\hat{}}}}_{{NH}_{3}} = [ {a}_{4} ( \hat{T} ) + {a}_{6} ( \hat{T} ) ] {\hat{Θ}}_{{NH}_{3}} + {\hat{c}}_{{NH}_{3}} {a}_{3} ( \hat{T} ) ( 1 - {\hat{Θ}}_{{NH}_{3}} ) - {a}_{5} ( \hat{T} ) {\hat{c}}_{{NO}_{x}} {\hat{Θ}}_{NH} & ( 8 ) \\ {{c}^{\dot{\hat{}}}}_{{NO}_{x}} = - {\hat{c}}_{{NO}_{x}} {a}_{0} {a}_{1} {m}_{EG}^{*} \hat{T} + {a}_{1} {n}_{{NO}_{x} , in}^{*} - \hat{Ω} {a}_{5} ( \hat{T} ) {\hat{Θ}}_{{NH}_{3}} {\hat{c}}_{{NO}_{x}} + {L}_{1} ( {c}_{{NO}_{x}} - {\hat{c}}_{{NO}_{x}} ) - {λ}_{1} sign ( {c}_{{NO}_{x}} - {\hat{c}}_{{NO}_{x}} ) & ( 9 ) \\ {{c}^{\dot{\hat{}}}}_{{NH}_{3}} = - {\hat{c}}_{{NH}_{3}} {a}_{0} {a}_{1} {m}_{EG}^{*} \hat{T} + {a}_{1} u + \hat{Ω} {c}_{{NH}_{3}} [ {a}_{4} ( \hat{T} ) {\hat{Θ}}_{{NH}_{3}} - {a}_{3} ( \hat{T} ) {\hat{c}}_{{NH}_{3}} ( 1 - {\hat{Θ}}_{{NH}_{3}} ) ] + {L}_{2} ( {c}_{{NH}_{3}} - {\hat{c}}_{{NH}_{3}} ) - {λ}_{2} sign ( {c}_{{NH}_{3}} - {\hat{c}}_{{NH}_{3}} ) & ( 10 ) \\ {Ω}^{\dot{\hat{}}} = - \frac{1}{ρ} \{ - {a}_{6} ( \hat{T} ) {\hat{c}}_{{NO}_{x}} {\hat{Θ}}_{{NH}_{3}} ( {c}_{{NO}_{x}} - {\hat{c}}_{{NO}_{x}} ) + [ {a}_{4} ( \hat{T} ) {\hat{Θ}}_{{NH}_{3}} - {a}_{3} ( \hat{T} ) {\hat{c}}_{{NH}_{3}} ( 1 - {\hat{Θ}}_{{NH}_{3}} ) ] ( {c}_{{NH}_{3}} - {\hat{c}}_{{NH}_{3}} ) \} & ( 11 )\end{matrix}$$

Wherein what are denoted with a superscript “Λ” are corresponding measurement values or estimation values of physical quantities. L₁, L₂, L₃, λ₁, λ₂ are constants, which may be adjusted and determined as needed. Besides, sign is a symbol function defined below:

$$sign ( y ) = \{ \begin{matrix}- 1 \text{:} & y < 0 \\ 0 \text{:} & y = 0 \\ 1 & y > 0\end{matrix}$$

In this way, the joint determining module (more specifically, model-based determining unit) may actually be regarded as an adaptive observer for ammonia storage capability and ammonia surface concentration of a catalyst, which operates in a “dark box” mode so as to determine the estimation values of the ammonia storage capability and the ammonia surface coverage of the catalyst (and other parameters, for example, the estimation value of the operation condition measurement value) based on the measurement value of the catalyst operation condition. FIG. 3 schematically shows a structural block diagram of a model-based determining unit.

It should be noted that what is depicted above is only a feasible example of determining the ammonia storage capacity and the ammonia surface coverage of the catalyst based on the measurement value of the catalyst operation condition. Based on the teaching and inspiration offered by the present invention, those skilled in the art would readily contemplate any other feasible embodiments. Thus, any transformation that considers the ammonia storage capacity as a variable when determining the estimation value of the catalyst ammonia surface coverage should fall within the scope of the present invention.

It should be understood that the apparatuses 100 and 200 as illustrated in FIG. 1 and FIG. 2 and depicted above may be implemented in various manners. For example, in some embodiments, the apparatuses 100 and 200 may be implemented as an integrated circuit (IC), an application-specific integrated circuit (ASIC), a system-on-chip (SOC), or any combination thereof. Alternatively or additionally, the apparatus 200 may also be implemented by a software module, i.e., implemented as a computer program product. The scope of the present invention is not limited thereto.

Now, refer to FIG. 4, which shows a flow chart of a method 400 used in an SCR system according to exemplary embodiments of the present invention. After method 400 starts, in step S402, a measurement value of at least one operation condition of a catalyst in the SCR system is acquired. In some embodiments of the present invention, the acquiring a measurement value of at least operation condition of the catalyst comprises acquiring at least one of concentration of nitrogen oxides in the catalyst, ammonia concentration in the catalyst; and temperature in the catalyst.

Next, the method 400 proceeds to step S404, in which ammonia storage capacity of the catalyst is determined based on the acquired measurement value so as to determine the ammonia surface coverage of the catalyst. According to some embodiments of the present invention, the determining ammonia storage capacity of the catalyst based on the acquired measurement value so as to determine ammonia surface coverage of the catalyst comprises: determining the ammonia surface coverage of the catalyst based on the acquired measurement value along with the ammonia storage capacity of the catalyst. Alternatively, the determining the ammonia surface coverage of the catalyst based on the acquired measurement value along with the ammonia storage capacity of the catalyst comprises: determining the ammonia storage capacity of the catalyst and the ammonia surface coverage of the catalyst with the measurement value as an independent variable by using a reaction model that characterizes chemical reaction properties of the catalyst.

In an embodiment based on the reaction model, the determining the ammonia storage capacity of the catalyst and the ammonia surface coverage of the catalyst with the measurement value as an independent variable by using a reaction model that characterizes chemical reaction properties of the catalyst comprises: measuring an observation value of at least one operation condition based on the acquired measurement value; and determining ammonia storage capacity of the catalyst using the measurement value and the observation value based on the reaction model so as to determine the ammonia surface coverage of the catalyst.

The method 400 ends after step S404.

It should be understood that the steps depicted in method 400 correspond to the operations and/or functions of respective modules in the apparatuses 100 and 200 as depicted above with reference to FIG. 1 and FIG. 2. Therefore, the features as depicted above with reference to respective modules of the apparatuses 100 and 200 are likewise suitable for the respective steps of the method 400. Moreover, respective steps as specified in method 400 may be implemented in different orders and/or in parallel.

Further, it should be understood that the method 400 as described with reference to FIG. 4 may be implemented via a computer program product. For example, the computer program product may comprise at least one computer-readable memory medium that has a computer-readable program code portion stored thereon. When the computer-readable code portion is executed by for example a processor, it is used to execute the steps of the method 400.

The spirit and principle of the present invention has been illustrated above with reference to a plurality of preferred embodiments.

According to the embodiments of the present invention, when determining or estimating ammonia surface coverage of a catalyst based on the measured operation condition of the catalyst, it would be unnecessary to always suppose the ammonia storage capacity of the catalyst to be a constant or determine it based on a specific kinetics property, like in the prior art. In contrast, embodiments of the present invention make no suppositions regarding the kinetics properties of the ammonia storage capacity, which can be a constant or a variable. In particular, ammonia storage capacity and ammonia surface coverage of the catalyst can be determined simultaneously based on a chemical reaction model of the catalyst. The ammonia storage capacity and ammonia surface coverage determined in this way can reflect the physical characteristics of the SCR catalyst more realistic and accurately. Further, the solution proposed in the present invention is easy to implement and operate in practice.

It should be noted that, the embodiments of the present invention can be implemented in software, hardware or the combination thereof. The hardware part can be implemented by a special logic; the software part can be stored in a memory and executed by a proper instruction execution system such as a microprocessor or a dedicated designed hardware. The normally skilled in the art may understand that the above method and apparatus may be implemented with a computer-executable instruction and/or by being incorporated in a processor controlled code, for example, such code is provided on a carrier medium such as a magnetic disk, CD, or DVD-ROM, or a programmable memory such as a read-only memory (firmware) or a data carrier such as an optical or electronic signal carrier. The apparatuses and their components in the present invention may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

It should be noted that although a plurality of modules or sub-modules of the device have been mentioned in the above detailed depiction, such partitioning is merely non-compulsory. In actuality, according to the embodiments of the present invention, the features and functions of the above described two or more modules may be embodied in one means. In turn, the features and functions of the above described one means may be further embodied in more modules.

Besides, although operations of the present methods are described in a particular order in the drawings, it does not require or imply that these operations must be performed according to this particular sequence, or a desired outcome can only be achieved by performing all shown operations. On the contrary, the execution order for the steps as depicted in the flowcharts may be varied. Additionally or alternatively, some steps may be omitted, a plurality of steps may be merged into one step, or a step may be divided into a plurality of steps for execution.

Although the present invention has been depicted with reference to a plurality of embodiments, it should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

What is claimed is:

1. An apparatus used in a selective catalytic reduction (SCR) system of a diesel engine, the SCR system comprising a catalyst to use ammonia to convert nitrogen oxides discharged from the diesel engine, the apparatus comprising:
an acquiring module coupled to the catalyst and configured to acquire a measurement value of at least one operation condition of the catalyst; and
a determining module coupled to the acquiring module and configured to determine ammonia storage capacity of the catalyst based on the acquired measurement value so as to determine ammonia surface coverage of the catalyst.

2. The apparatus according to claim 1, wherein the determining module comprises:
a joint determining module configured to determine the ammonia surface coverage of the catalyst based on the measurement value acquired by the acquiring module along with the ammonia storage capacity of the catalyst.

3. The apparatus according to claim 2, wherein the joint determining module comprises:
a model-based determining module configured to determine the ammonia storage capacity of the catalyst and the ammonia surface coverage of the catalyst with the measurement value as an independent variable based on a reaction model that characterizes chemical reaction properties of the catalyst.

4. The apparatus according to claim 3, wherein the model-based determining module comprises:
a calculating module configured to calculate an observation value of at least one operation condition based on the measurement value acquired by the acquiring module; and
a first determining module configured to determine the ammonia storage capacity of the catalyst and the ammonia surface coverage of the catalyst using the measurement value and the observation value based on the reaction model.

5. The apparatus according to claim 1, wherein the acquiring module comprises at least one of the following:
a first concentration acquiring module configured to acquire concentration of nitrogen oxides in the catalyst;
a second concentration acquiring module configured to acquire ammonia concentration in the catalyst; and
a temperature acquiring module configured to acquire temperature in the catalyst.

6. A method used in a selective catalytic reduction (SCR) system of a diesel engine, the SCR system comprising a catalyst to use ammonia to convert nitrogen oxides discharged from the diesel engine, the method comprising:
acquiring a measurement value of at least one operation condition of the catalyst; and
determining ammonia storage capacity of the catalyst based on the acquired measurement value so as to determine ammonia surface coverage of the catalyst.

7. The method according to claim 6, wherein the determining ammonia storage capacity of the catalyst based on the acquired measurement value so as to determine ammonia surface coverage of the catalyst comprises:
determining the ammonia surface coverage of the catalyst based on the acquired measurement value along with the ammonia storage capacity of the catalyst.

8. The method according to claim 7, wherein determining the ammonia surface coverage of the catalyst based on the acquired measurement value along with the ammonia storage capacity of the catalyst comprises:
determining the ammonia storage capacity of the catalyst and the ammonia surface coverage of the catalyst with the measurement value as an independent variable by using a reaction model that characterizes chemical reaction properties of the catalyst.

9. The method according to claim 8, wherein the determining the ammonia storage capacity of the catalyst and the ammonia surface coverage of the catalyst with the measurement value as an independent variable by using a reaction model that characterizes chemical reaction properties of the catalyst comprises:
calculating an observation value of at least one operation condition based on the acquired measurement value; and
determining the ammonia storage capacity of the catalyst so as to determine the ammonia surface coverage of the catalyst by using the measurement value and the observation value based on the reaction model.

10. The method according to claim 6, wherein the acquiring a measurement value of at least one operation condition of the catalyst comprises acquiring at least one of: concentration of nitrogen oxides in the catalyst, ammonia concentration in the catalyst; and temperature in the catalyst.

11. A computer program product having a computer instruction program included in a computer readable storage medium, wherein when the program is executed by a device, the device is caused to perform corresponding actions, the program comprising:
a first instruction for acquiring a measurement value of at least one operation condition of the catalyst; and
a second instruction for determining ammonia storage capacity of the catalyst based on the acquired measurement value so as to determine ammonia surface coverage of the catalyst.

12. The computer program product according to claim 11, wherein the second instruction comprises:
a third instruction for determining the ammonia surface coverage of the catalyst based on the acquired measurement value along with the ammonia storage capacity of the catalyst.

13. The computer program product according to claim 12, wherein the third instruction comprises:
a fourth instruction for determining the ammonia storage capacity of the catalyst and the ammonia surface coverage of the catalyst with the measurement value as an independent variable based on a reaction model that characterizes chemical reaction properties of the catalyst.

14. The computer program product according to claim 13, wherein the fourth instruction comprises:
a fifth instruction for calculating an observation value of at least one operation condition based on the acquired measurement value; and
a sixth instruction for determining the ammonia storage capacity of the catalyst and the ammonia surface coverage of the catalyst using the measurement value and the observation value based on the reaction model.

15. The computer program product according to claim 11, wherein the first instruction comprises an instruction for acquiring at least one of the following: concentration of nitrogen oxides in the catalyst, ammonia concentration in the catalyst; and temperature in the catalyst.
